(19) United States
(12) Patent Application Publication
(10) Pub. No.: US 2025/0168600 A1
(43) Pub. Date: May 22, 2025

(54) Method and Apparatus for Multicast and Broadcast Service

(71) Applicant: Telefonaktiebolaget LM Ericsson (publ), Stockholm (SE)

(72) Inventors: Jie Ling, Shanghai (CN); Juying Gan, Shanghai (CN); Shabnam Sultana, Montreal (CA)

(21) Appl. No.: 18/833,044

(22) PCT Filed: Jan. 17, 2023
(86) PCT No.: PCT/CN2023/072581

§ 371 Date: Jul. 25, 2024

(30) Foreign Application Priority Data
Jan. 27, 2022 (WO) PCT/CN2022/074364

(51) Int. Cl. H04W 4/06; H04L 12/18

(52) U.S. Cl. CPC H04W 4/06; H04L 12/1845

(57) ABSTRACT

Various embodiments of the present disclosure provide a method for multicast/broadcast service. The method which may be performed by a network entity comprises: receiving a message including area information from an application server. The area information indicates a service area related to a multicast/broadcast service session. In accordance with an exemplary embodiment, the method further comprises: determining a multicast/broadcast-session management function based at least in part on the area information.

### FIELD OF THE INVENTION

The present disclosure generally relates to communication networks, and more specifically, to a method and apparatus for multicast and broadcast service (MBS).

### BACKGROUND

This section introduces aspects that may facilitate a better understanding of the disclosure. Accordingly, the statements of this section are to be read in this light and are not to be understood as admissions about what is in the prior art or what is not in the prior art.

Architectural enhancements to the fifth generation (5G) system using new radio (NR) to support multicast and broadcast communication services are specified by the 3rd generation partnership project (3GPP), e.g., as described in technical specification (TS) 23.247 v17.1.0. Multicast/broadcast service (MBS) is a point-to-multipoint service in which data is transmitted from a single source entity to multiple recipients, either to all users in a broadcast service area, or to users in a multicast group as defined in TS 22.146 v16.0.0. The corresponding types of MBS session may include broadcast session and multicast session.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

For multicast and broadcast communications, an application function (AF) may start an MBS session towards 5G core (5GC) to provide an MBS service to a user equipment (UE). The MBS service may comprise a local MBS service provided in one MBS service area or a location-dependent MBS service provided in one or more MBS service areas. Different multicast and broadcast-session management functions (MB-SMFs) may be assigned for different MBS service areas in an MBS session. According to existing solutions, an MB-SMF may be selected in a temporary mobile group identity (TMGI) allocation procedure which may be performed to obtain a TMGI to identify an MBS session. However, the MB-SMF selected in the TMGI allocation procedure may be different from the MB-SMF serving the MBS service area of the MBS session. In this case, the selected MB-SMF may not be able to serve the MBS session very well. Therefore, it may be desirable to enhance MB-SMF selection in a more efficient way.

Various exemplary embodiments of the present disclosure propose a solution for MBS, which can enable an MB-SMF to be selected during TMGI allocation based on information about MBS service area(s), so that the selected MB-SMF can serve the MBS session effectively.

According to a first aspect of the present disclosure, there is provided a method performed by a network entity. The method comprises: receiving a message including area information from an application server (e.g., an AF, etc.). The area information may indicate a service area related to an MBS session. In accordance with an exemplary embodiment, the method further comprises: determining an MB-SMF based at least in part on the area information.

In accordance with an exemplary embodiment, the message may be a TMGI allocation request message.

In accordance with an exemplary embodiment, the service area indicated by the area information may be a potential service area for one or more TMGIs which are to be allocated in response to the TMGI allocation request message.

In accordance with an exemplary embodiment, the service area indicated by the area information may be equal to or larger than an MBS service area which is indicated to the network entity by the application server in an MBS session creation request.

In accordance with an exemplary embodiment, when the area information is in external area format, the method according to the first aspect of the present disclosure may further comprise: translating the area information in the external area format into the area information in internal area format.

In accordance with an exemplary embodiment, the area information in the external area format may include geographical area information and/or civic address information.

In accordance with an exemplary embodiment, the area information in the internal area format may include a cell identifier (ID) list and/or a tracking area identifier (TAI) list.

In accordance with an exemplary embodiment, the MB-SMF may be determined by the network entity via transmitting a query for the MB-SMF to a database and receiving a response to the query from the database. In an embodiment, the query may include the area information, and the response may indicate one or more MB-SMFs matching the area information.

In accordance with an exemplary embodiment, the network entity may determine the MB-SMF by selecting the MB-SMF from the one or more MB-SMFs.

In accordance with an exemplary embodiment, the database may be a network repository function (NRF) entity.

In accordance with an exemplary embodiment, the service area indicated by the area information may cover one or more MBS service areas for area sessions of the MBS session for location-dependent MBS in a session management function (SMF) service area.

In accordance with an exemplary embodiment, the network entity may be a network exposure function (NEF) entity, or a multicast/broadcast service function (MBSF) entity, or a combination of the NEF entity and the MBSF entity.

According to a second aspect of the present disclosure, there is provided an apparatus which may be implemented as a network entity. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a network entity. The apparatus may comprise a receiving unit and a determining unit. In accordance with some exemplary embodiments, the receiving unit may be operable to carry out at least the receiving step of the method according to the first aspect of the present disclosure. The determining unit may be operable to carry out at least the determining step of the method according to the first aspect of the present disclosure.

According to a fifth aspect of the present disclosure, there is provided a method performed by an application server (e.g., an AF, etc.). The method comprises: determining area information which indicates a service area related to an MBS session. In accordance with an exemplary embodiment, the method further comprises: transmitting, to a network entity (e.g., an NEF entity, an MBSF entity, an NEF/MBSF entity, etc.), a message including the area information for MB-SMF selection.

In accordance with an exemplary embodiment, the message transmitted by the application server according to the fifth aspect of the present disclosure may correspond to the message received by the network entity according to the first aspect of the present disclosure. Thus, the message as described according to the first and fifth aspects of the present disclosure may have the same or similar contents and/or feature elements.

Similarly, in accordance with an exemplary embodiment, the area information as described according to the fifth aspect of the present disclosure may correspond to the area information as described according to the first aspect of the present disclosure. Thus, the area information as described according to the first and fifth aspects of the present disclosure may have the same or similar contents and/or feature elements.

In accordance with an exemplary embodiment, the message may be a TMGI allocation request message.

In accordance with an exemplary embodiment, the service area indicated by the area information may be a potential service area for one or more TMGIs which are to be allocated in response to the TMGI allocation request message.

In accordance with an exemplary embodiment, the service area indicated by the area information may be equal to or larger than an MBS service area which is indicated to the network entity by the application server in an MBS session creation request.

In accordance with an exemplary embodiment, the area information may include one or more of: geographical area information, civic address information, a cell ID list, and a TAI list.

In accordance with an exemplary embodiment, the service area indicated by the area information may cover one or more MBS service areas for area sessions of the MBS session for location-dependent MBS in an SMF service area.

According to a sixth aspect of the present disclosure, there is provided an apparatus which may be implemented as an application server. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as an application server. The apparatus may comprise a determining unit and a transmitting unit. In accordance with some exemplary embodiments, the determining unit may be operable to carry out at least the determining step of the method according to the fifth aspect of the present disclosure. The transmitting unit may be operable to carry out at least the transmitting step of the method according to the fifth aspect of the present disclosure.

According to a ninth aspect of the present disclosure, there is provided a method performed by a database (e.g., an NRF entity, etc.). The method comprises: receiving a query for an MB-SMF from a network entity (e.g., an NEF entity, an MBSF entity, an NEF/MBSF entity, etc.). The query may include area information which indicates a service area related to an MBS session. In accordance with an exemplary embodiment, the method further comprises: transmitting a response to the query to the network entity. The response may indicate one or more MB-SMFs matching the area information.

In accordance with an exemplary embodiment, the area information as described according to the ninth aspect of the present disclosure may correspond to the area information as described according to the first aspect of the present disclosure. Thus, the area information as described according to the first and ninth aspects of the present disclosure may have the same or similar contents and/or feature elements.

In accordance with an exemplary embodiment, the area information may be received by the database in a TMGI allocation procedure.

In accordance with an exemplary embodiment, the service area indicated by the area information may be a potential service area for one or more TMGIs which are to be allocated according to the TMGI allocation procedure.

In accordance with an exemplary embodiment, the service area indicated by the area information may be equal to or larger than an MBS service area which is indicated to the network entity by an application server (e.g., an AF, etc.) in an MBS session creation request.

In accordance with an exemplary embodiment, the service area indicated by the area information may cover one or more MBS service areas for area sessions of the MBS session for location-dependent MBS in an SMF service area.

According to a tenth aspect of the present disclosure, there is provided an apparatus which may be implemented as a database. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a database. The apparatus may comprise a receiving unit and a transmitting unit. In accordance with some exemplary embodiments, the receiving unit may be operable to carry out at least the receiving step of the method according to the ninth aspect of the present disclosure. The transmitting unit may be operable to carry out at least the transmitting step of the method according to the ninth aspect of the present disclosure.

According to various exemplary embodiments, MBS service area information may be provided to a network entity such as NEF/MBSF by an application server such as AF, e.g., in a TMGI allocation request. The MBS service area information may be used to enhance MB-SMF selection, so as to achieve improved MBS session performance.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1 is a diagram illustrating exemplary delivery methods according to an embodiment of the present disclosure;

FIG. 2A is a diagram illustrating an exemplary MBS reference architecture according to an embodiment of the present disclosure;

FIG. 2B is a diagram illustrating an exemplary 5G system architecture for MBS using the reference point representation according to an embodiment of the present disclosure;

FIG. 2C is a diagram illustrating an exemplary interworking system architecture according to an embodiment of the present disclosure;

FIG. 3A is a diagram illustrating exemplary MBS session creation without policy and charging control (PCC) according to an embodiment of the present disclosure;

FIG. 3B is a diagram illustrating exemplary MBS session creation with PCC according to an embodiment of the present disclosure;

FIG. 4 is a diagram illustrating exemplary MBS session creation without PCC according to another embodiment of the present disclosure;

FIGS. 5A-5C are flowcharts illustrating various methods according to some embodiments of the present disclosure;

FIG. 6 is a block diagram illustrating an apparatus according to an embodiment of the present disclosure; and

FIG. 7A-7C are block diagrams illustrating various apparatus according to some embodiments of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

The MBS architecture defined in clause 5 of 3GPP TS 23.247 v17.1.0 follows the 5G System (5GS) architectural principles as defined in 3GPP TS 23.501 v17.3.0, enabling distribution of the MBS data from the 5GS ingress to next generation-radio access network (NG-RAN) node(s) and then to a UE. The MBS architecture may provide efficient usage of radio access network (RAN) and core network (CN) resources, with an emphasis on radio interface efficiency; and provide efficient transport for a variety of multicast and broadcast services. Multicast-broadcast service for roaming is not supported in this release. Interaction between multicast-broadcast service and support of deployments topologies with specific SMF service areas is not specified in this release.

The MBS may also provide functionalities such as local MBS service, authorization of multicast MBS and quality of service (QOS) differentiation, e.g., as described in clause 6 of 3GPP TS 23.247 v17.1.0. MBS traffic may be delivered from a single data source (e.g. an application service provider) to multiple UEs. Depending on many factors, there may be several delivery methods which may be used to deliver the MBS traffic in the 5GS. For clarity, delivery methods are not referred to as unicast/multicast/broadcast but as described in 3GPP TS 23.247 v17.1.0. The term “unicast delivery” refers to a mechanism by which application data and signaling between the UE and the application server are delivered using packet data unit (PDU) session within the 3GPP network and using individual UE and application server addresses (e.g., Internet protocol (IP) addresses) between the 3GPP network and the application server. It may not be equivalent to 5G core (5GC) individual MBS traffic delivery method defined in 3GPP TS 23.247 v17.1.0.

Between 5GC and NG-RAN, there are two possible delivery methods as below to transmit the MBS data:

5GC individual MBS traffic delivery method: This method is only applied for multicast MBS session. 5GC receives a single copy of MBS data packets and delivers separate copies of those MBS data packets to individual UEs via per-UE PDU sessions, hence for each such UE one PDU session is required to be associated with a multicast session.

5GC shared MBS traffic delivery method: This method is applied for both broadcast and multicast MBS session. 5GC receives a single copy of MBS data packets and delivers a single copy of those MBS packets to an NG-RAN node, which then delivers the packets to one or multiple UEs.

The 5GC shared MBS traffic delivery method may be required in all MBS deployments. The 5GC individual MBS traffic delivery method may be required to enable mobility when there is an NG-RAN deployment with non-homogeneous support of MBS.

For the multicast session, a single copy of MBS data packets received by the CN may be delivered via 5GC individual MBS traffic delivery method for some UE(s) and via 5GC shared MBS traffic delivery method for other UEs.

Between the NG-RAN and the UE, two delivery methods may be available for the transmission of MBS data packets over radio interface:

Point-to-Point (PTP) delivery method: NG-RAN delivers separate copies of MBS data packets over radio interface to individual UE(s).

Point-to-Multipoint (PTM) delivery method: NG-RAN delivers a single copy of MBS data packets over radio interface to multiple UEs.

NG-RAN may use a combination of PTP/PTM to deliver an MBS data packets to UEs. The PTP and PTM delivery methods are defined in RAN WGs.

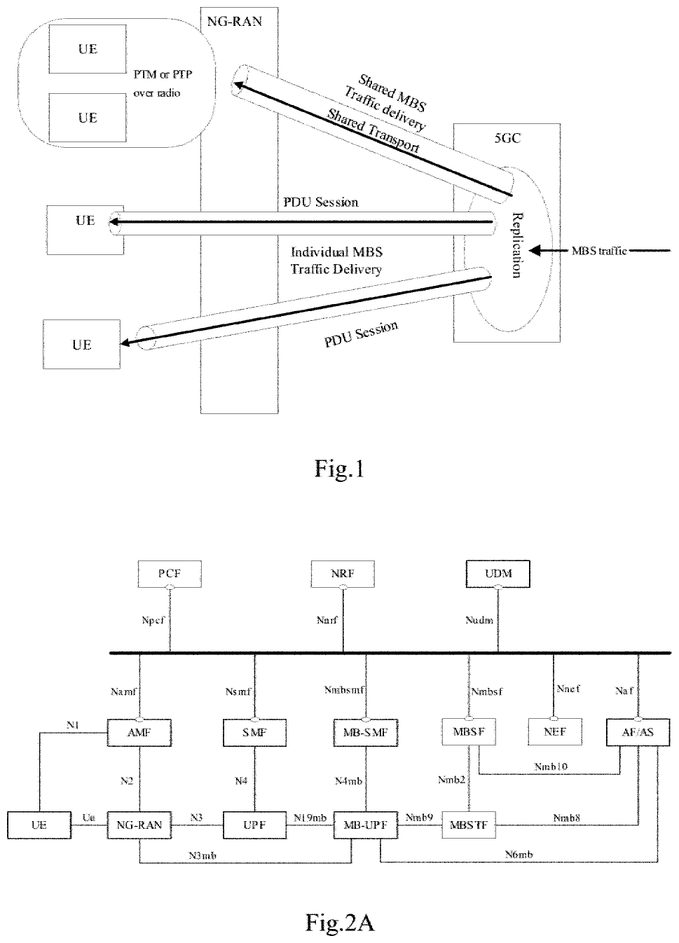

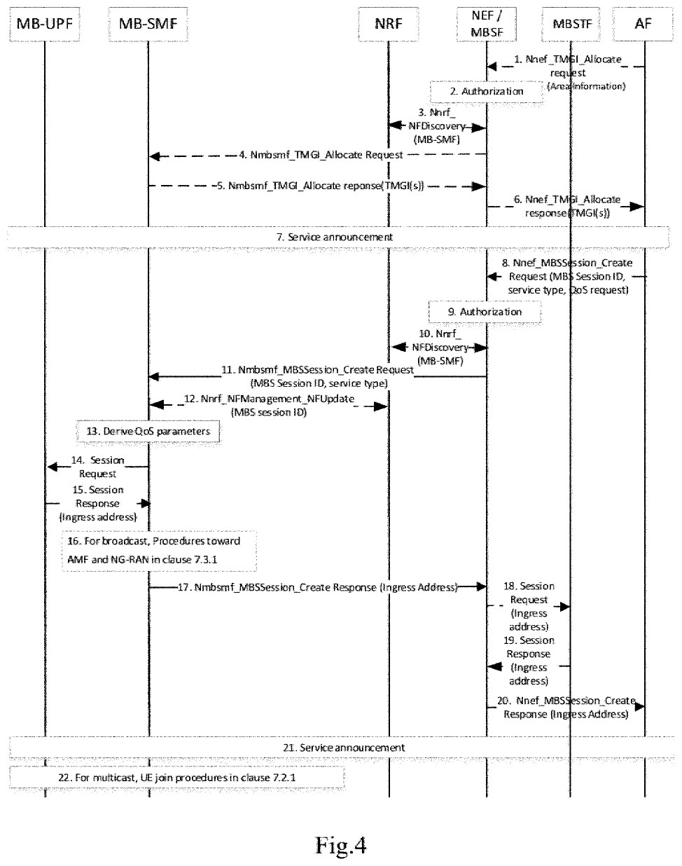

FIG. 1 is a diagram illustrating exemplary delivery methods according to an embodiment of the present disclosure. As depicted in FIG. 1 (which may correspond to FIG. 4.1-1 of 3GPP TS 23.247 v17.1.0), 5GC shared MBS traffic delivery method (with PTP or PTM delivery) and 5GC individual MBS traffic delivery method may be used at the same time for a multicast MBS session. For MBS broadcast communication, only 5GC shared MBS traffic delivery method with PTM delivery is applicable. For MBS multicast communication, if the NG-RAN node supports MBS, the network may need to use the 5GC shared MBS traffic delivery method for MBS data transmission. The exception is when the UE moves between NG-RAN node not supporting MBS (with 5GC individual MBS traffic delivery method) and NG-RAN node supporting MBS, there is temporary co-existence between 5GC shared MBS traffic delivery method and 5GC individual MBS traffic delivery method, e.g., as described in clause 6.3 of 3GPP TS 23.247 v17.1.0.

For MBS multicast communication, the switching between 5GC shared MBS traffic delivery method and 5GC individual MBS traffic delivery method may be supported. The UE mobility between RAN nodes both supporting MBS, and between a RAN node supporting MBS and a RAN node not supporting MBS may be supported, e.g., as described in clause 6.3 of 3GPP TS 23.247 v17.1.0.

For MBS multicast communication, the switching between PTP and PTM delivery methods for 5GC shared MBS traffic delivery may be supported. NG-RAN is the decision point for switching between PTP and PTM delivery methods.

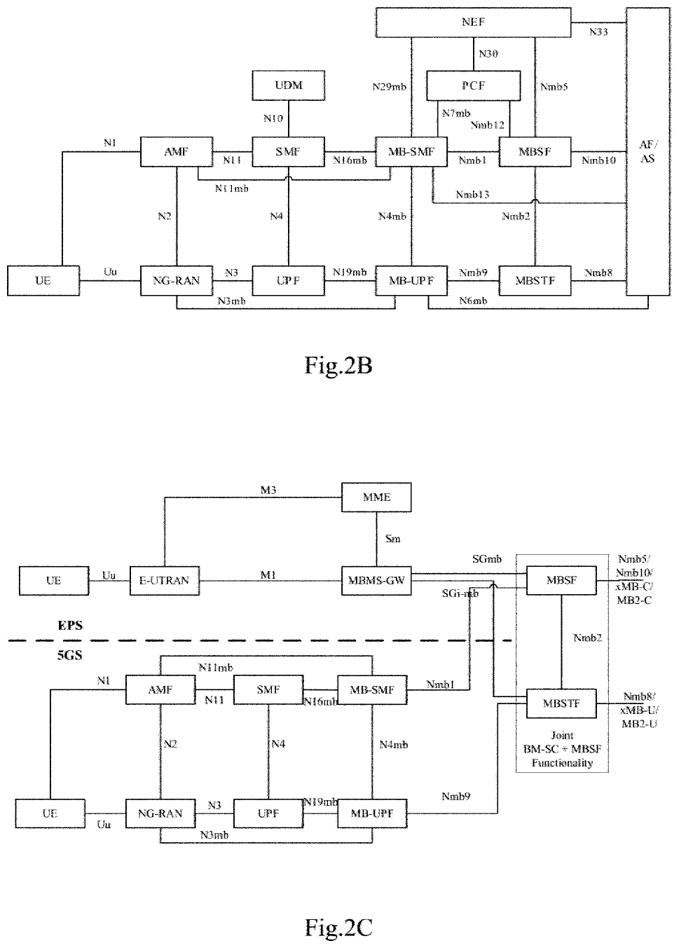

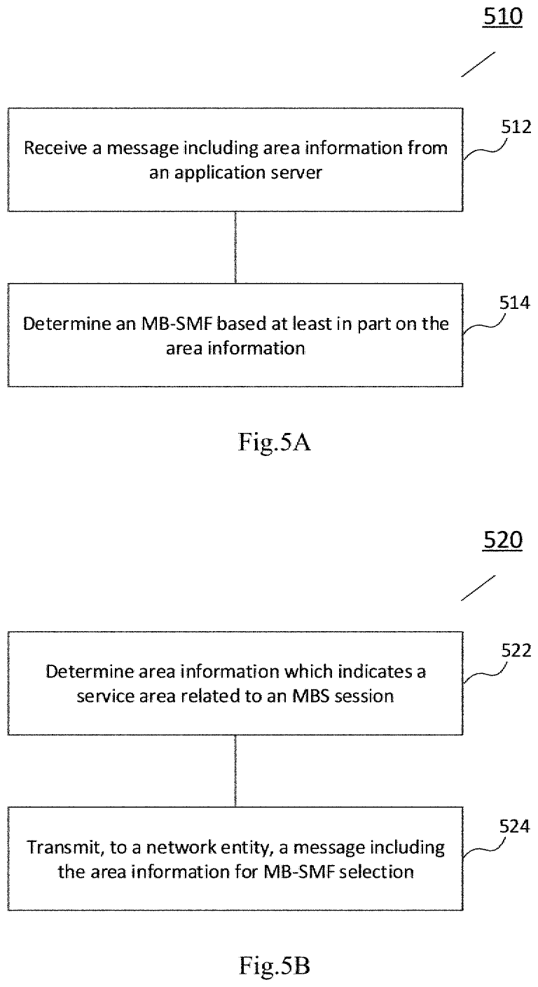

FIG. 2A is a diagram illustrating an exemplary MBS reference architecture according to an embodiment of the present disclosure. The MBS reference architecture shown in FIG. 2A may correspond to a 5G system architecture for MBS as illustrated in FIG. 5.1-1 of 3GPP TS 23.247 v17.1.0. In this general architecture, service-based interfaces may be used within the control plane. Annex C of 3GPP TS 23.247 v17.1.0 describes support for interworking at reference points xMB and MB2. It is noted that the MBSF is optional and may be collocated with the NEF or AF/AS, and the multicast/broadcast service transport function (MBSTF) may be an optional network function. The existing service-based interfaces of Nnrf, Nudm, and Nsmf may be enhanced to support MBS. The existing service-based interfaces of Npcf and Nnef may also be enhanced to support MBS. An MBS-enabled AF may use either Nmbsf or Nnef to interact with the MBSF.

FIG. 2B is a diagram illustrating an exemplary 5G system architecture for MBS using the reference point representation according to an embodiment of the present disclosure. The exemplary 5G system architecture for MBS shown in FIG. 2B may correspond to a 5G system architecture for MBS as illustrated in FIG. 5.1-2 of 3GPP TS 23.247 v17.1.0. In this 5G system architecture, the existing reference points of N1, N2, N4, N10, N11, N30 and N33 may be enhanced to support MBS. Regarding the functionalities, Nmb13, N29mb and Nmb1 are identical, Nmb5 and Nmb10 are identical, Nmb9 and N6mb are identical.

FIG. 2C is a diagram illustrating an exemplary interworking system architecture according to an embodiment of the present disclosure. Interworking between MBS and evolved multimedia broadcast/multicast service (eMBMS) at service layer functionality applies in some cases where the same multicast/broadcast service is provided via eMBMS and MBS. The MBS-eMBMS interworking system architecture at service layer as shown in FIG. 2C may be implemented as a general architecture for interworking with evolved packet system (EPS), corresponding to FIG. 5.2-1 of 3GPP TS 23.247 v17.1.0, i.e., a system architecture for interworking between evolved-universal terrestrial radio access network/evolved packet core (E-UTRAN/EPC) eMBMS and MBS at service layer, with collocated broadcast/multicast-service center (BM-SC) and MBSF/MBSTF functionalities. The BM-SC+MBSF/MBSTF may expose common Nmb5/Nmb10/xMB-C/MB2-C and Nmb8/xMB-U/MB2-U reference points to the NEF and/or AF/AS. A common TMGI may be used towards the AF/AS. The TMGI may also be used as identifier for transport over E-UTRAN/EPC. It is noted that MB2-C/U may be both legacy reference points and 5GS reference points.

In accordance with an exemplary embodiment, an AF may use an MBS session creation procedure to start an MBS session towards 5GC. This procedure may consist of TMGI allocation and MBS session creation, and they may be applicable to both multicast and broadcast communications unless otherwise stated. As described in clause 7.1.1.2 of 3GPP TS 23.247 v17.1.0, for multicast, MBS session establishment procedure triggered by UE join requests may follow the MBS session creation procedure to reserve resources towards NG-RAN. For broadcast, the MBS session start procedure to reserve resources towards NG-RAN may be triggered by the MBS session creation procedure. For both broadcast and multicast communication, the TMGI allocation may be separated from the MBS session creation request. For multicast communication, the TMGI allocation procedure may be applicable if a TMGI is used as an MBS session ID.

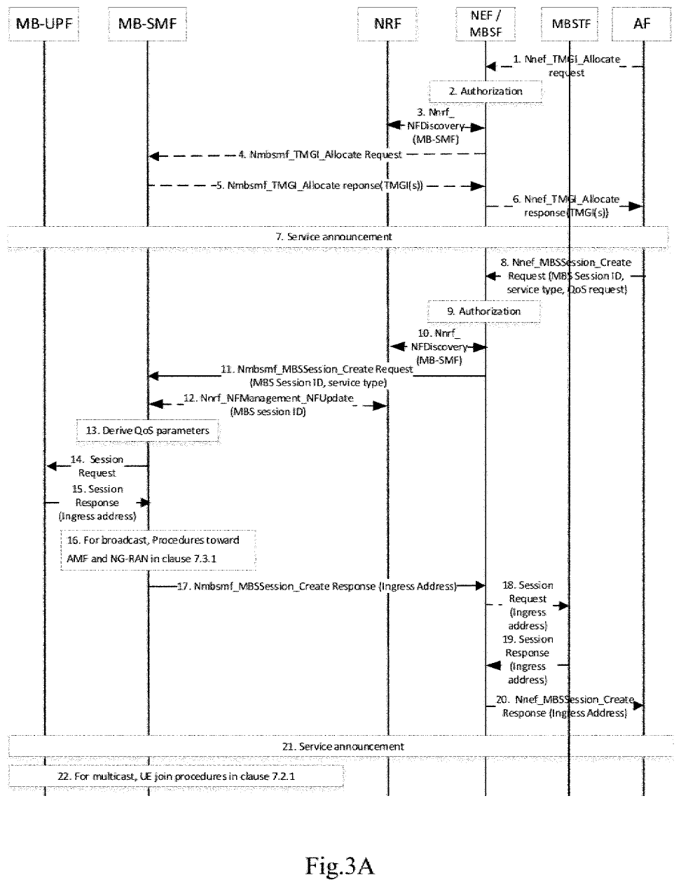

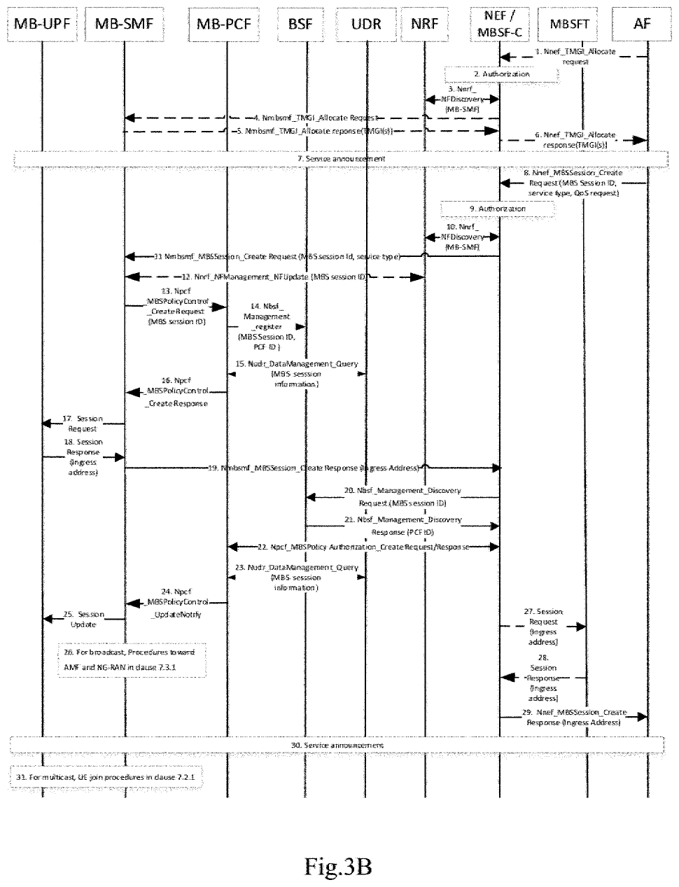

FIG. 3A is a diagram illustrating exemplary MBS session creation without PCC according to an embodiment of the present disclosure. Some network elements such as a multicast/broadcast user plane function (MB-UPF), an MB-SMF, an NRF, an NEF/MBSF, an MBSTF and an AF may be involved in the exemplary procedure illustrated in FIG. 3A. It can be appreciated that network elements and signaling messages shown in FIG. 3A are just as examples, and more or less alternative network elements and signaling messages may be involved in the MBS session creation procedure according to various embodiments of the present disclosure. As shown in FIG. 3A, the MBS session creation procedure may include the following steps:
1. The AF may send an Nnef_TMGI_Allocate Request (TMGI number) message to the NEF/MBSF to request allocation of a TMGI(s) to identify new MBS session(s). It is noted that depending on the network deployment and use case, the MB-SMF may receive one or more requests from the AF directly, or via the NEF, or via the MBSF, or via a combination of NEF and MBSF.
2. The NEF may check authorization of the AF. It is noted that the NEF may not be required if the AF is in trusted domain.
3. The NEF/MBSF may discover and select an MB-SMF using the NRF or based on local configuration.
4. The NEF/MBSF may send an Nmbsmf_TMGI_Allocate Request (TMGI number) message to the MB-SMF.
5. The MB-SMF may allocate TMGI(s) and return the TMGI(s) to the NEF/MBSF via the Nmbsmf_TMGI_Allocate Response (TMGI(s), expiration time).
6. The NEF and/or the MBSF may respond to the AF by sending an Nnef_TMGI_Allocate Response (TMGI(s), expiration time).
7. The AF may perform a service announcement towards UEs. The AF may inform the UEs about MBS session information with MBS session ID, e.g., TMGI, source specific IP multicast address (SSM), and possibly other information e.g., MBS service area information, session description information, etc. The MBS service area information may be a cell ID list, a TAI list, geographical area information and/or civic address information. Amongst them, the cell ID list and the TAI list may only be used by AFs who reside in trust domain, and when the AFs are aware of such information. The UE may need to be aware if the service is broadcast or multicast to decide if JOIN is to be performed.
8. The AF of content provider may provide description for an MBS session (possibly providing information for a previously allocated TMGI to NEF via an Nnef_MBSSession_Create request ([MBS session ID], service type, MBS information, [TMGI allocation indication]). If steps 1-6 have not been executed before, the AF may provide an SSM or it may request that the network allocates an identifier for the MBS session (i.e., TMGI). The AF may provide the service type (i.e. either multicast service or broadcast service). The MBS session information may further include QOS requirements and Any UE indication (indicating whether a multicast MBS session is “open to any UEs”), MBS service area information, start and end time of the MBS session and MBS session state (active/inactive). In addition, the MBS information may also indicate whether the allocation of an ingress transport address is requested. If geographical area information or civic address information is provided by the AF as MBS service area information, the NEF/MBSF may translate the MBS service area information into a cell ID list or a TAI list.
9. The NEF/MBSF may check authorization of the content provider.
10. The NEF/MBSF may discover MB-SMF candidates and select an MB-SMF as an ingress control node, possibly based on MBS service area information. If a TMGI is included in step 8, the NEF/MBSF may find the MB-SMF based on that TMGI.
11. The NEF/MBSF may send an Nmbsmf_MBSSession_Create Request (MBS session ID, service type, TMGI allocation indication, MBS service area information, ingress transport address request indication) to the MB-SMF, to request the MB-SMF to reserve ingress resources for an MBS distribution session. The NEF/MBSF may provide an MBS session ID or request allocation of a TMGI, and indicate the requested service type (either multicast service or broadcast service) and MBS session state (active/inactive). It may also indicate that the allocation of an ingress transport address is requested if this is requested in step 8, or if the MBSF decides to insert an MBSTF into the user plane for the MBS session. The request may also include the Any UE indication if provided in step 8. The MBS service area information may be provided by the NEF/MBSF to the MB-SMF if provided by the AF in step 8.
12. If requested to do so, or if a source specific multicast is provided as the MBS session ID in step 11, the MB-SMF may allocate a TMGI. If a source specific multicast is provided as the MBS session ID in step 11, the MB-SMF may update its NF profile at the NRF with the serving MBS session ID. If the MBS service area information is received in step 11, the MB-SMF may update its NF profile at the NRF with that information. It is noted that if the TMGI is used to represent an MBS session, the MB-SMF may not need to update the NRF if the TMGI range(s) supported by the MB-SMF is already included in the MB-SMF profile when the MB-SMF registers itself into the NRF.
13. The MB-SMF may derive the required QoS parameters locally.
14. The MB-SMF may select the MB-UPF. If the allocation of an ingress transport address is requested in step 11, the MB-SMF may request the MB-UPF to reserve user plane ingress resources. If multicast transport of the MBS data towards RAN nodes is to be used, the MB-SMF may also request the MB-UPF to reserve for the outgoing data a tunnel endpoint and the related identifiers (source IP address, SSM and general packet radio service tunneling protocol (GTP) tunnel ID) and to forward data received at the user plane ingress resource using that tunnel endpoint. If the allocation of an ingress transport address is not requested in step 11, the MB-SMF may provide the SSM received as MBS session ID to the MB-UPF and request the MB-UPF to join the corresponding multicast tree from the content provider. The MB-SMF may also defer the configuration to join the corresponding multicast tree e.g., based on information that the session is inactive, QoS requirements and MBS start/end time until receiving the first query for the MBS session as part of the establishment procedure (e.g., as described in clause 7.2.1.3 of 3GPP TS 23.247 v17.1.0), or until receiving a request to activate the MBS session via the MBS session update procedure (e.g., as described in clause 7.1.1.6 or 7.1.1.7 of 3GPP TS 23.247 v17.1.0).
15. If requested, the MB-UPF may select an ingress address (IP address and port) and a tunnel endpoint for the outgoing data and provide it to the MB-SMF.
16. For broadcast communication, the MB-SMF may continue the procedure towards the AMF and NG-RAN (e.g., as described in clause 7.3.1 of 3GPP TS 23.247 v17.1.0).
17. The MB-SMF may indicate the possibly allocated ingress address to the NEF/MBSF. The MB-SMF may include TMGI if it is allocated in step 9. It may also indicate the success or failure of reserving transmission resources.
18. [Optional] If the MBSF decides to use an MBSTF, the NEF/MBSF may provide the ingress address received in step 14 towards the MBSTF as downlink (DL) destination. If the allocation of an ingress transport address is requested in step 8, the MBSF may request the MBSTF to allocate the user plane ingress resources. If the allocation of an ingress transport address is not requested in step 8, the MBSF may provide the SSM received as multicast session ID in step 8 and request the MBSTF to join the corresponding multicast tree from the content provider.
19. [Conditional on step 18] If requested, the MBSTF may select an ingress address (IP address and port) and provide it to the NEF/MBSF.
20. The NEF/MBSF-C may indicate the possibly allocated ingress address and other parameters (e.g. TMGI) to the AF via an Nnef_MBSSession_Create response ([TMGI], [Allocated ingress address])). If the MBS session ID is not provided in step 8, or the MBS session ID is SSM, the NEF/MBSF may provide the allocated TMGI. If the AF requests the allocation of an ingress transport address, the message may also include the allocated ingress address.
21. Same as step 7. The AF may also perform a service announcement at this stage.
22. For multicast communication, depending on configuration the UEs can join the MBS session (e.g., as described in clause 7.2.1 of 3GPP TS 23.247 v17.1.0).

It can be appreciated that steps 1-6 as illustrated in FIG. 3A may be optional and only applicable if TMGI is used as MBS session ID and required to be pre-allocated.

FIG. 3B is a diagram illustrating exemplary MBS session creation with PCC according to an embodiment of the present disclosure. Some network elements such as an MB-UPF, an MB-SMF, a multicast/broadcast policy charging function (MB-PCF), a binding support function (BSF), a unified data repository (UDR), an NRF, an NEF/MBSF-C, an MBSTF and an AF may be involved in the exemplary procedure illustrated in FIG. 3B. It can be appreciated that network elements and signaling messages shown in FIG. 3B are just as examples, and more or less alternative network elements and signaling messages may be involved in the MBS session creation procedure according to various embodiments of the present disclosure. As shown in FIG. 3B, the MBS session creation procedure may include the following steps:
1 to 10. Same as steps 1-10 shown in FIG. 3A. Step 1 shown in FIG. 3B may include an application ID.
11. Same as step 11 shown in FIG. 3A. In addition, the NEF/MBSF may decide based on local configuration or based on parameters received in step 8 (e.g., whether the session comprises several data flows) whether it will invoke the Npcf_MBSPolicy Authorization service for the MBS session. If so, the NEF/MBSF may indicate to the MB-SMF that it will also provide a policy authorization for the MBS session to the PCF.
12. Same as step 12 shown in FIG. 3A.
13. [Optional] If the NEF/MBSF indicated in step 11 that it will also provide a policy authorization for the broadcast session to the PCF, the MB-SMF may select a PCF and send an Npcf_MBSPolicyControl_Create Request (MBS session ID) for the MBS session towards the PCF, and defer step 25 until receiving an Npcf_MBSPolicyControl_UpdateNotify for the MBS session. Otherwise, the MB-SMF may decide based on local configuration whether to invoke the Npcf_MBSPolicyControl service.
14. [Conditional on step 13] The PCF may register at the BSF that it handles the MBS session by using Nbsf_management_Register Request (MBS session ID, PCF ID). It may provide an identifier that the policy association is for MBS and the MBS session ID, its own PCF ID and optionally its PCF set ID.
15. [Optional] The PCF may retrieve preconfigured policy information for the MBS session based on the multicast address as multicast session ID (e.g., applicable QoS, the MBS Session-Aggregated Maximum Bit Rate (AMBR) and/or default 5G QoS indicator (5QI)) from the UDR.
16. [Conditional on step 13] The PCF may respond with an Npcf_MBSPolicyControl_Create Response (MBS policy, e.g., as described in clause 6.10 of 3GPP TS 23.247 v17.1.0) with policies for the MBS session ID. The MBS policy may include the session-AMBR for the MBS session and 5QI for the MBS QoS flow.
17-18. Same as steps 14-15 in FIG. 3A.
19. Same as step 17 in FIG. 3A.
20-21. [Optional] The NEF/MBSF may use the BSF discovery service to discover the PCF serving the MBS session with the MBS session ID by using Nbsf_management_Discovery operation.
22. [Optional] The NEF/MBSF may send an Npcf_MBSPolicy Authorization_Create Request to the PCF with the MBS session ID and MBS session information (that may include an application ID). The PCF may determine whether the request is authorized. If the request is authorized, the PCF may derive the required QoS parameters based on the information provided by the NEF and determine whether this QoS is allowed (e.g., according to the policy input configuration in the UDR). If the request is not authorized or the required QoS is not allowed, the PCF may indicate so in the response to the NEF.
23. [Optional] The PCF may perform data management with the UDR via Nudr DataManagement_Query.
24. [Conditional] If the PCF determines updated policies for the MBS session in step 21, it may update the policy information at the MB-SMF. When obtaining a request for the creation of a policy association (signal 21) for a broadcast session, for which it already performs policy control towards an MB-SMF, the PCF may always provide a policy update to the MB-SMF; if no real policy update is required, the PCF may repeat previous policies or send an empty update message.
25. [Conditional] If required by the updated policies, the MB-SMF may update the MB-UPF accordingly.
26. When obtaining an MBS policy control update from the PCF (signal 23) for a broadcast session, the MB-SMF may continue the procedure towards the AMF and NG-RAN (e.g., as described in clause 7.3.1 of 3GPP TS 23.247 v17.1.0) to request the allocation of resources to for the transmission of the broadcast session.
27-31. Same as steps 18-22 in FIG. 3A. It is noted that steps 27-31 may be executed in parallel to steps 20-26.

It can be appreciated that steps 1-7 as illustrated in FIG. 3B may be optional and only applicable if TMGI is used as MBS session ID and required to be pre-allocated.

In accordance with an exemplary embodiment, the MBS service may comprise local MBS service and location-dependent MBS service. A local MBS service is an MBS service provided in one MBS service area. A location-dependent MBS service is an MBS service provided in several MBS service area(s). An MBS service area may be identified by a cell list or a tracking area list. The MBS service area information may be geographical area information or civic address information, and the NEF/MBSF may translate the location information to a cell ID list or a TAI list as MBS service area information, e.g., as described in clause 7.1.1.2 of 3GPP TS 23.247 v17.1.0. The MBS service area may be updated by the AF for both multicast MBS session and broadcast MBS session, e.g., as described in clause 7.1.1.6 of 3GPP TS 23.247 v17.1.0 (more details are described in clause 7.2.4 for multicast MBS session and in clause 7.3.4 for broadcast MBS session).

For a local MBS service, only UEs within the MBS service area may receive content data, while UEs outside the MBS service area may not be allowed to receive location specific content. For multicast MBS service, UEs outside the MBS service area may not be allowed to join the MBS service, and the network may not deliver location specific content anymore to the UEs moved out of the MBS service area. Depending on policy, for the multicast MBS service the network may remove UEs outside the MBS service area of the MBS session from the MBS session context after a grace period. The SMF may subscribe at the AMF to notifications about “UE moving in or out of a subscribed ‘Area Of Interest”’ event.

For multicast communication, the local MBS may be supported via 5GC individual MBS traffic delivery towards RAN nodes not supporting MBS. If the SMF obtains a notification that the UE is no longer in the MBS service area, the SMF may terminate the 5GC individual MBS traffic delivery towards the UE.

The UE may be able to obtain service area information of the local multicast service via MBS service announcement or via non-access stratum (NAS) signaling (UE Session Join Accept/Reject including cell ID list or TAI list). If the UE session join procedure fails due to the UE being outside the MBS service area, the UE may not attempt to join the multicast session again until the UE moves inside the MBS service area. When the UE session join procedure succeeds and if the multicast session is deactivated, the UE may not perform monitoring the session activation notification and any other information related to the multicast session identified by an MBS session ID over the radio if outside the MBS service area.

It is noted that the broadcast communication service is the service provided simultaneously to all UEs in a geographical area, therefore for broadcast it is naturally a local MBS service.

A location-dependent MBS service may be identified by an MBS session ID, and provided in several MBS service areas. The location-dependent MBS service may enable distribution of different content data to different MBS service areas. The same MBS session ID may be used but a different area session ID may be used for each MBS service area. The area session ID is used, in combination with the MBS session ID, to uniquely identify the service area specific part of the content data of the MBS service within 5GS. The network may support the location-dependent content distribution for the location dependent MBS services, while UEs may be only aware of the MBS session ID (i.e. UEs may not be required to be aware of the area session IDs). When a UE moves to a new MBS service area, content data from the new MBS service area may be delivered to the UE, and the network may cease to deliver the content data from the old MBS service areas to the UE. For multicast MBS service, UEs outside all MBS service areas of the location-dependent MBS session may not be allowed to join the MBS service. When a UE moves out of an MBS service area and there is no other MBS service area for the MBS session, the network may cease to deliver the content data to the UE. Depending on policy, for the multicast MBS service the network may remove UEs outside all MBS service areas of the location-dependent MBS session from the multicast MBS session context after a grace period. The SMF may subscribe at the AMF to notifications about UE moving in or out of all MBS service areas of the location-dependent MBS session.

For multicast communication towards an NG-RAN supporting MBS, the NG-RAN node may handle mobility of UEs within the MBS session between MBS service areas served by the same NG-RAN without interaction with the SMF.

For multicast communication, location-dependent MBS services may be supported via 5GC individual MBS traffic delivery towards RAN nodes not supporting MBS. If the SMF determines that the UE is in another MBS service area of the multicast session, the SMF may configure the UPF to send multicast data relating to the new MBS service area towards the UE.

Information about different MBS service areas for a location-dependent MBS service may be provided by one or several AFs or may be configured. Different ingress points for location-dependent points for the MBS session may be supported for different MBS service area dependent content of the MBS session; and different MB-SMFs and/or MB-UPFs may be assigned for different MBS service areas in an MBS session. When the different MB-SMFs are assigned for different MBS service areas in an MBS session, the same TMGI may be allocated for this MBS session.

The area session ID may be allocated by the MB-SMF in an MBS session creation procedure. The MB-SMF may allocate an area session ID for each MBS services area which is unique within the MBS session. The MB-SMF may need to further ensure there is no MBS service area overlapping with other MBS service areas that share the same MBS session ID.

In 3GPP TS 23.247 v17.1.0, deployments topologies with specific SMF service areas are not supported, as a result, location-dependent service using multicast communication is not supported when a UE moves outside its SMF service area.

For the location-dependent service provided in different MBS service areas within the same SMF service area, it is assumed that one MB-SMF may be used for an MBS session. An example of location-dependent MBS is a nationwide weather forecast service with local weather reports. In an embodiment, an area session ID may be equivalent to a flow ID, e.g., as described in 3GPP TS 23.246 v16.1.0.

As described with respect to FIG. 3A and FIG. 3B, a TMGI may be allocated/updated by performing a service operation such as Nnef_MBSTMGI_Allocate service operation. This service operation may be used by an NF service consumer to request allocation of TMGI(s), or to refresh the expiry time for already allocated TMGI(s). The inputs required for the service operation may include the number of TMGIs (which may be zero if only a refresh of expiry time is requested). In an embodiment, some inputs such as TMGI(s) to be refreshed may be optional for the service operation. The outputs required for the service operation may include TMGIs, expiry time, Success or not.

According to the MBS session creation procedures as shown in FIG. 3A and FIG. 3B, an MB-SMF may be selected in response to a TMGI allocation request. However, the MB-SMF selected in TMGI allocation may be different from the one which can serve the MBS service area in MBS session creation, and thus the selected MB-SMF may not be able to provide proper services for the MBS session.

Various exemplary embodiments of the present disclosure propose a solution for MBS, which introduces MBS service area information for MB-SMF selection to enable MBS service such as local MBS and location-dependent MBS, especially when there are multiple MB-SMFs deployed for different areas in the same region (e.g., an SMF service area). In accordance with an exemplary embodiment, MBS service area information may be included in an Nnef_TMGI_Allocation request by an AF, and an NEF/MBSF may consider the MBS service area information when selecting an MB-SMF, so that the MB-SMF selected in TMGI allocation can serve the MBS service area in MBS session creation.

FIG. 4 is a diagram illustrating exemplary MBS session creation without PCC according to another embodiment of the present disclosure. Similar to FIG. 3A, some network elements such as an MB-UPF, an MB-SMF, an NRF, an NEF/MBSF, an MBSTF and an AF may be involved in the exemplary procedure illustrated in FIG. 4. It can be appreciated that network elements and signaling messages shown in FIG. 4 are just as examples, and more or less alternative network elements and signaling messages may be involved in the MBS session creation procedure according to various embodiments of the present disclosure. As shown in FIG. 4, the MBS session creation procedure may include the following steps:
1. The AF may send an Nnef_TMGI_Allocate Request (TMGI number, [MBS service area information for MB-SMF selection]) message to the NEF/MBSF to request allocation of a TMGI(s) to identify new MBS session(s). The MBS service area information for MB-SMF selection may indicate the possible service area for those TMGI(s) to be allocated. The service area indicated by the MBS service area information may need to be equal to or larger than the MBS service area provided by the AF in step 8. It is noted that depending on the network deployment and use case, the MB-SMF may receive one or more requests from the AF directly, or via the NEF, or via the MBSF, or via a combination of NEF and MBSF.
2. The NEF/MBSF may check authorization of the AF. In an embodiment, if geographical area information and/or civic address information is provided by the AF as the MBS service area information for MB-SMF selection, the NEF/MBSF may perform the translation. It is noted that the NEF may not be required if the AF is in trusted domain.
3. The NEF/MBSF may discover and select an MB-SMF using the NRF or based on local configuration, possibly based on the MBS service area information for MB-SMF selection.
4. The NEF/MBSF may send an Nmbsmf_TMGI_Allocate Request (TMGI number) message to the MB-SMF.
5. The MB-SMF may allocate TMGI(s) and return the TMGI(s) to the NEF/MBSF via the Nmbsmf_TMGI_Allocate response (TMGI(s), expiration time).
6. The NEF and/or the MBSF may respond to the AF by sending an Nnef_TMGI_Allocate Response (TMGI(s), expiration time).
7. The AF may perform a service announcement towards UEs. The AF may inform the UEs about MBS session information with MBS session ID, e.g., TMGI, SSM, and possibly other information e.g., MBS service area information, session description information, etc. The MBS service area information can be a cell ID list, a TAI list, geographical area information and/or civic address information. Amongst them, the cell ID list and the TAI list may only be used by AFs who reside in trust domain, and when the AFs are aware of such information. The UE may need to be aware if the service is broadcast or multicast to decide if JOIN is to be performed.
8. The AF of content provider may provide description for an MBS session (possibly providing information for a previously allocated TMGI to NEF via an Nnef_MBSSession_Create request (([MBS Session ID], service type, MBS information, [TMGI allocation indication]). If steps 1-6 have not been executed before, the AF may provide an SSM or it may request that the network allocates an identifier for the MBS session (i.e., TMGI). The AF may provide the service type (i.e. either multicast service or broadcast service). The MBS session information may further include QoS requirements and Any UE indication (indicating whether a multicast MBS session is “open to any UEs”), MBS service area information, start and end time of the MBS session and MBS session state (active/inactive). In addition, the MBS information may also indicate whether the allocation of an ingress transport address is requested. If geographical area information or civic address information is provided by the AF as MBS service area information, the NEF/MBSF may translate the MBS service area information into a cell ID list or a TAI list.
9. The NEF/MBSF may check authorization of the content provider.
10. The NEF/MBSF may discover MB-SMF candidates and select an MB-SMF as an ingress control node, possibly based on MBS service area information. If a TMGI is included in step 8, the NEF/MBSF may find the MB-SMF based on that TMGI.
11. The NEF/MBSF may send an Nmbsmf_MBSSession_Create Request (MBS Session ID, service type, TMGI allocation indication, MBS service area information, ingress transport address request indication) to the MB-SMF, to request the MB-SMF to reserve ingress resources for a MBS distribution session. The NEF/MBSF may provide an MBS Session ID or request allocation of a TMGI, and indicate the requested service type (either multicast service or broadcast service) and MBS session state (active/inactive). It may also indicate that the allocation of an ingress transport address is requested if this is requested in step 8, or if the MBSF decides to insert an MBSTF into the user plane for the MBS session. The request may also include the Any UE indication if provided in step 8. The MBS service area information may be provided by the NEF/MBSF to the MB-SMF if provided by the AF in step 8.
12. If requested to do so, or if a source specific multicast is provided as the MBS session ID in step 11, the MB-SMF may allocate a TMGI. If a source specific multicast is provided as the MBS session ID in step 11, the MB-SMF may update its NF profile at the NRF with the serving MBS session ID. If the MBS service area information is received in step 11, the MB-SMF may update its NF profile at the NRF with that information. It is noted that if the TMGI is used to represent an MBS session, the MB-SMF may not need to update the NRF if the TMGI range(s) supported by the MB-SMF is already included in the MB-SMF profile when the MB-SMF registers itself into the NRF.
13. The MB-SMF may derive the required QoS parameters locally.
14. The MB-SMF may select the MB-UPF. If the allocation of an ingress transport address is requested in step 11, the MB-SMF may request the MB-UPF to reserve user plane ingress resources. If multicast transport of the MBS data towards RAN nodes is to be used, the MB-SMF may also request the MB-UPF to reserve for the outgoing data a tunnel endpoint and the related identifiers (source IP address, SSM and GTP tunnel ID) and to forward data received at the user plane ingress resource using that tunnel endpoint. If the allocation of an ingress transport address is not requested in step 11, the MB-SMF may provide the SSM received as MBS session ID to the MB-UPF and request the MB-UPF to join the corresponding multicast tree from the content provider. The MB-SMF may also defer the configuration to join the corresponding multicast tree e.g., based on information that the session is inactive, QoS requirements and MBS start/end time until receiving the first query for the MBS session as part of the establishment procedure (e.g., as described in clause 7.2.1.3 of 3GPP TS 23.247 v17.1.0), or until receiving a request to activate the MBS session via the MBS session update procedure (e.g., as described in clause 7.1.1.6 or 7.1.1.7 of 3GPP TS 23.247 v17.1.0).
15. If requested, the MB-UPF may select an ingress address (IP address and port) and a tunnel endpoint for the outgoing data and provide it to the MB-SMF.
16. For broadcast communication, the MB-SMF may continue the procedure towards the AMF and NG-RAN (e.g., as described in clause 7.3.1 of 3GPP TS 23.247 v17.1.0).
17. The MB-SMF may indicate the possibly allocated ingress address to the NEF/MBSF. The MB-SMF may include TMGI if it is allocated in step 9. It may also indicate the success or failure of reserving transmission resources.
18. [Optional] If the MBSF decides to use an MBSTF, the NEF/MBSF may provide the ingress address received in step 14 towards the MBSTF as DL destination. If the allocation of an ingress transport address is requested in step 8, the MBSF may request the MBSTF to allocate the user plane ingress resources. If the allocation of an ingress transport address is not requested in step 8, the MBSF may provide the SSM received as multicast session ID in step 8 and request the MBSTF to join the corresponding multicast tree from the content provider.
19. [Conditional on step 18] If requested, the MBSTF may select an ingress address (IP address and port) and provide it to the NEF/MBSF.
20. The NEF/MBSF-C may indicate the possibly allocated ingress address and other parameters (e.g. TMGI) to the AF via an Nnef_MBSSession_Create response ([TMGI], [Allocated ingress address])). If the MBS session ID is not provided in step 8, or the MBS session ID is SSM, the NEF/MBSF may provide the allocated TMGI. If the AF requests the allocation of an ingress transport address, the message may also include the allocated ingress address.
21. Same as step 7. The AF may also perform a service announcement at this stage.
22. For multicast communication, depending on configuration the UEs can join the MBS session (e.g., as described in clause 7.2.1 of 3GPP TS 23.247 v17.1.0).

It can be appreciated that steps 1-6 as illustrated in FIG. 4 may be optional and only applicable if TMGI is used as MBS session ID and required to be pre-allocated.

It also can be appreciated that although some exemplary embodiments are described in the context of MBS session creation without PCC, various embodiments described in the present disclosure may also be applicable to MBS session creation with PCC, so that an AF may provide MBS service area information for MB-SMF selection in a TMGI allocation procedure.

In accordance with an exemplary embodiment, for location-dependent MBS, the MBS session creation procedure may be performed as shown in FIG. 4 with the following additions:

Multiple AFs may start the same multicast session with different contents in different MBS service areas. The NEF may select an MB-SMF as ingress control node(s) for different MBS service areas.

If presented, the NEF may map possible external identifiers for MBS service areas to network-internal identifiers (e.g., a list of cells, TAIs, etc.).

The MB-SMF may allocate an area session ID, and update its NF profile towards the NRF with the MBS session ID, MBS service area information and the area session ID. For a location-dependent service provided in different MBS service areas within the same SMF service area, it may be assumed that one MB-SMF is used for an MBS session. In an embodiment, the MBS service area information for MB-SMF selection may cover the MBS service areas for all area sessions in the SMF service area.

The policy of multicast session may be determined based on the service requirements per MBS session. The MB-SMF may associate the same service requirement QoS flow in different area sessions with the same QoS flow identifier (QFI).

The MB-SMF may select the MB-UPF based on the MBS service area.

All MBS service area(s) of the location-dependent MBS session may be indicated to the UE in the service announcement (e.g., as described in clause 6.11 of 3GPP TS 23.247 v17.1.0).

As described with respect to FIG. 4, a TMGI may be allocated/updated by performing a service operation such as Nnef_MBSTMGI_Allocate service operation. This service operation may be used by an NF service consumer to request allocation of TMGI(s), or to refresh the expiry time for already allocated TMGI(s). The inputs required for the service operation may include the number of TMGIs (which may be zero if only a refresh of expiry time is requested). In accordance with an exemplary embodiment, the optional inputs for the service operation may include TMGI(s) to be refreshed and MBS service area information for MB-SMF selection. The outputs required for the service operation may include TMGIs, expiry time, Success or not.

FIG. 5A is a flowchart illustrating a method 510 according to some embodiments of the present disclosure. The method 510 illustrated in FIG. 5A may be performed by a network entity (e.g., an NEF entity, an MBSF entity, a combination of the NEF entity and the MBSF entity, etc.) or an apparatus communicatively coupled to the network entity. In accordance with an exemplary embodiment, the network entity may be configured to discover an MB-SMF for an MBS session.

According to the exemplary method 510 illustrated in FIG. 5A, the network entity may receive a message including area information from an application server (e.g., an AF, etc.), as shown in block 512. The area information may indicate a service area related to an MBS session. In accordance with an exemplary embodiment, the network entity may determine an MB-SMF based at least in part on the area information, as shown in block 514.

In accordance with an exemplary embodiment, the message may be a TMGI allocation request message, and/or any other suitable message which may carry the area information from the application server to the network entity in a TMGI allocation procedure.

In accordance with an exemplary embodiment, the service area indicated by the area information may be a potential service area for one or more TMGIs which are to be allocated in response to the TMGI allocation request message.

In accordance with an exemplary embodiment, the service area indicated by the area information may be equal to or larger than an MBS service area which is indicated to the network entity by the application server in an MBS session creation request.

In accordance with an exemplary embodiment, when the area information is in external area format, the network entity may translate the area information in the external area format into the area information in internal area format. In an embodiment, the area information in the external area format may include geographical area information and/or civic address information. In another embodiment, the area information in the internal area format may include a cell ID list and/or a TAI list.

In accordance with an exemplary embodiment, the MB-SMF may be determined by the network entity via transmitting a query for the MB-SMF to a database (e.g., an NRF entity or any other suitable repository capable of storing data information, etc.) and receiving a response to the query from the database. In an embodiment, the query may include the area information, and the response may indicate one or more MB-SMFs matching the area information. In another embodiment, the network entity may determine the MB-SMF by selecting the MB-SMF from the one or more MB-SMFs.

In accordance with an exemplary embodiment, the service area indicated by the area information may cover one or more MBS service areas for area sessions of the MBS session for location-dependent MBS in an SMF service area.

FIG. 5B is a flowchart illustrating a method 520 according to some embodiments of the present disclosure. The method 520 illustrated in FIG. 5B may be performed by an application server (e.g., an AF, etc.) or an apparatus communicatively coupled to the application server. In accordance with an exemplary embodiment, the application server may be configured to support or provision various application services such as MBS services to one or more network entities and/or devices.

According to the exemplary method 520 illustrated in FIG. 5B, the application server may determine area information which indicates a service area related to an MBS session, as shown in block 522. In accordance with an exemplary embodiment, the application server may transmit, to a network entity (e.g., the network entity as described with respect to FIG. 5A), a message including the area information for MB-SMF selection, as shown in block 524.

In accordance with an exemplary embodiment, the message transmitted by the application server according to the method 520 may correspond to the message received by the network entity according to the method 510. Thus, the message as described with respect to FIG. 5A and FIG. 5B may have the same or similar contents and/or feature elements.

Similarly, in accordance with an exemplary embodiment, the area information as described according to the method 520 may correspond to the area information as described according to the method 510. Thus, the area information as described with respect to FIG. 5A and FIG. 5B may have the same or similar contents and/or feature elements.

In accordance with an exemplary embodiment, the area information may include one or more of: geographical area information, civic address information, a cell ID list, and a TAI list.

FIG. 5C is a flowchart illustrating a method 530 according to some embodiments of the present disclosure. The method 530 illustrated in FIG. 5C may be performed by a database (e.g., an NRF entity, or any other suitable repository capable of storing data information, etc.) or an apparatus communicatively coupled to the database. In accordance with an exemplary embodiment, the database may be configured to support data information query by a network entity.

According to the exemplary method 530 illustrated in FIG. 5C, the database may receive a query for an MB-SMF from a network entity (e.g., the network entity as described with respect to FIG. 5A), as shown in block 532. The query may include area information which indicates a service area related to an MBS session. In accordance with an exemplary embodiment, the database may transmit a response to the query to the network entity, as shown in block 534. The response may indicate one or more MB-SMFs matching the area information.

In accordance with an exemplary embodiment, the area information as described according to the method 530 may correspond to the area information as described according to the method 510. Thus, the area information as described with respect to FIG. 5A and FIG. 5C may have the same or similar contents and/or feature elements.

In accordance with an exemplary embodiment, the area information may be received by the database in a TMGI allocation procedure. In an embodiment, the query may be a discovery message (e.g., an Nnrf_NFDiscovery message, etc.) transmitted to the database by the network entity.

In accordance with an exemplary embodiment, the service area indicated by the area information may be a potential service area for one or more TMGIs which are to be allocated according to the TMGI allocation procedure. In an embodiment, the service area indicated by the area information may be equal to or larger than an MBS service area which is indicated to the network entity by an application server (e.g., an AF, etc.) in an MBS session creation request.

In accordance with an exemplary embodiment, the service area indicated by the area information may cover one or more MBS service areas for area sessions of the MBS session for location-dependent MBS in an SMF service area.

The various blocks shown in FIGS. 5A-5C may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

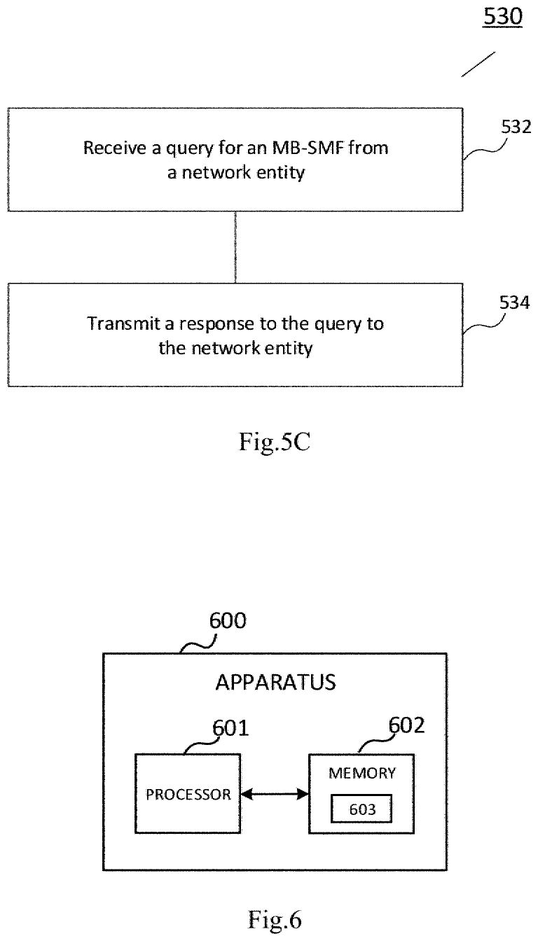

FIG. 6 is a block diagram illustrating an apparatus 600 according to various embodiments of the present disclosure. As shown in FIG. 6, the apparatus 600 may comprise one or more processors such as processor 601 and one or more memories such as memory 602 storing computer program codes 603. The memory 602 may be non-transitory machine/processor/computer readable storage medium. In accordance with some exemplary embodiments, the apparatus 600 may be implemented as an integrated circuit chip or module that can be plugged or installed into a network entity as described with respect to FIG. 5A, or an application server as described with respect to FIG. 5B, or a database as described with respect to FIG. 5C. In such cases, the apparatus 600 may be implemented as a network entity as described with respect to FIG. 5A, or an application server as described with respect to FIG. 5B, or a database as described with respect to FIG. 5C.

In some implementations, the one or more memories 602 and the computer program codes 603 may be configured to, with the one or more processors 601, cause the apparatus 600 at least to perform any operation of the method as described in connection with FIG. 5A. In other implementations, the one or more memories 602 and the computer program codes 603 may be configured to, with the one or more processors 601, cause the apparatus 600 at least to perform any operation of the method as described in connection with FIG. 5B. In other implementations, the one or more memories 602 and the computer program codes 603 may be configured to, with the one or more processors 601, cause the apparatus 600 at least to perform any operation of the method as described in connection with FIG. 5C. Alternatively or additionally, the one or more memories 602 and the computer program codes 603 may be configured to, with the one or more processors 601, cause the apparatus 600 at least to perform more or less operations to implement the proposed methods according to the exemplary embodiments of the present disclosure.

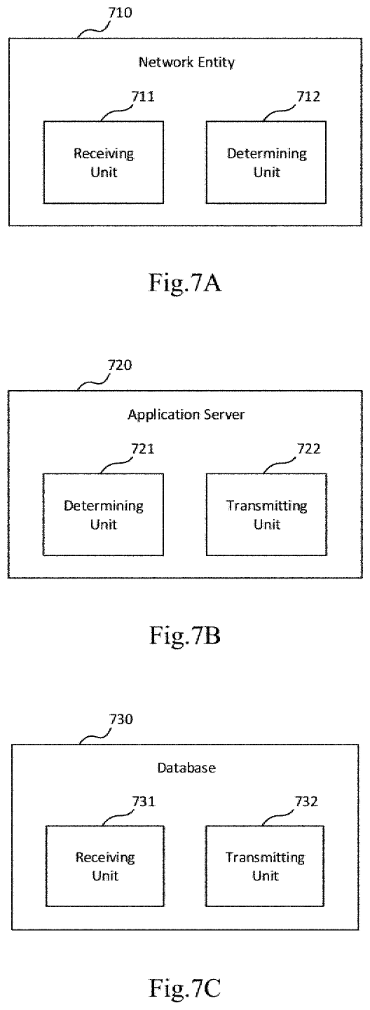

FIG. 7A is a block diagram illustrating an apparatus 710 according to some embodiments of the present disclosure. As shown in FIG. 7A, the apparatus 710 may comprise a receiving unit 711 and a determining unit 712. In an exemplary embodiment, the apparatus 710 may be implemented in a network entity (e.g., an NEF, an MBSF, an NEF/MBSF, etc.). The receiving unit 711 may be operable to carry out the operation in block 512, and the determining unit 712 may be operable to carry out the operation in block 514. Optionally, the receiving unit 711 and/or the determining unit 712 may be operable to carry out more or less operations to implement the proposed methods according to the exemplary embodiments of the present disclosure. In an embodiment, the apparatus 710 may comprise a transmitting unit (not shown in FIG. 7A) for transmitting various kinds of information from the apparatus 710 to other devices (e.g., a database, a server, etc.).

FIG. 7B is a block diagram illustrating an apparatus 720 according to some embodiments of the present disclosure. As shown in FIG. 7B, the apparatus 720 may comprise a determining unit 721 and a transmitting unit 722. In an exemplary embodiment, the apparatus 720 may be implemented in an application server (e.g., an AF, etc.). The determining unit 721 may be operable to carry out the operation in block 522, and the transmitting unit 722 may be operable to carry out the operation in block 524. Optionally, the determining unit 721 and/or the transmitting unit 722 may be operable to carry out more or less operations to implement the proposed methods according to the exemplary embodiments of the present disclosure. In an embodiment, the apparatus 720 may comprise a receiving unit (not shown in FIG. 7B) for receiving various kinds of information from other devices (e.g., a network entity, a database, etc.).

FIG. 7C is a block diagram illustrating an apparatus 730 according to some embodiments of the present disclosure. As shown in FIG. 7C, the apparatus 730 may comprise a receiving unit 731 and a transmitting unit 732. In an exemplary embodiment, the apparatus 730 may be implemented in a database (e.g., an NRF, etc.). The receiving unit 731 may be operable to carry out the operation in block 532, and the transmitting unit 732 may be operable to carry out the operation in block 534. Optionally, the receiving unit 731 and/or the transmitting unit 732 may be operable to carry out more or less operations to implement the proposed methods according to the exemplary embodiments of the present disclosure.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-34. (canceled)

35. A method performed by a network entity, comprising:
receiving, from an application server, a message to request a temporary mobile group identity (TMGI) allocation for a multicast/broadcast service (MBS) session, including area information, wherein the area information indicates a service area for the TMGI to be allocated; and
determining a multicast/broadcast-session management function (MB-SMF) based at least in part on the area information for the allocation of the TMGI.

36. The method of claim 35, wherein the area information is in external area format, the method further comprising:
translating the area information in the external area format into the area information in internal area format.

37. The method of claim 36, wherein the area information in the external area format includes geographical area information and/or civic address information.

38. The method of claim 36, wherein the area information in the internal area format includes a cell identifier (ID) list and/or a tracking area identifier (TAI) list.

39. The method of claim 35, wherein the MB-SMF is determined by the network entity by:
transmitting a query for the MB-SMF to a database, wherein the query includes the area information;
receiving a response to the query from the database, wherein the response indicates one or more MB-SMFs matching the area information; and
selecting the MB-SMF from the one or more MB-SMFs.

40. The method of claim 39, wherein the database is a network repository function (NRF) entity.

41. The method of claim 35, wherein the service area indicated by the area information covers one or more MBS service areas for area sessions of the MBS session for location-dependent MBS in a session management function (SMF) service area.

42. The method of claim 35, wherein the network entity is a network exposure function (NEF) entity, or a multicast/broadcast service function (MBSF) entity, or a combination of the NEF entity and the MBSF entity.

43. A network entity, comprising:
one or more processors; and
one or more memories comprising computer program codes,
the one or more memories and the computer program codes being configured to, with the one or more processors, cause the network entity at least to:
receive, from an application server, a message to request a temporary mobile group identity (TMGI) allocation for a multicast/broadcast service (MBS) session, including area information, wherein the area information indicates a service area for the TMGI to be allocated; and
determine a multicast/broadcast-session management function (MB-SMF) based at least in part on the area information for the allocation of the TMGI.

44. A method performed by an application server, comprising:
transmitting, to a network entity, a message to request a temporary mobile group identity (TMGI) allocation for a multicast/broadcast service (MBS) session including area information, wherein the area information indicates a service area for the TMGI to be allocated; and
receiving the allocated TMGI for the MBS session, wherein the allocated TMGI is based on the area information.

45. The method of claim 44, wherein the area information includes one or more of:
geographical area information, civic address information, a cell identifier (ID) list, and a tracking area identifier (TAI) list.

46. The method of claim 44, wherein the service area indicated by the area information covers one or more MBS service areas for area sessions of the MBS session for location-dependent MBS in a session management function (SMF) service area.

47. The method of claim 44, wherein the network entity is a network exposure function (NEF) entity, or a multicast/broadcast service function (MBSF) entity, or a combination of the NEF entity and the MBSF entity.
